(19) United States
(12) Patent Application Publication
(10) Pub. No.: US 2024/0253701 A1
(43) Pub. Date: Aug. 1, 2024

(54) VEHICLE BODY FRAME STRUCTURE

(71) Applicant: SUBARU CORPORATION, Tokyo (JP)

(72) Inventor: Takako KAI, Tokyo (JP)

(21) Appl. No.: 18/541,754

(22) Filed: Dec. 15, 2023

(30) Foreign Application Priority Data
Jan. 31, 2023 (JP) 2023-013187

(51) Int. Cl. B62D 21/03; B62D 25/02; B62D 25/20

(52) U.S. Cl. CPC B62D 21/03; B62D 25/025; B62D 25/20

(57) ABSTRACT

A vehicle body frame structure for a vehicle includes: side sills extending in a vehicle front-rear direction on respective sides in a vehicle width direction; a cross member extending in the width direction in a vehicle central part in the front-rear direction and coupled to the side sills at respective vehicle ends in the width direction; and a floor pan extending toward a vehicle rear side of the cross member in a vehicle lower part. The cross member includes a cross member front and a cross member rear coupled to each other. A vehicle rear upper end of the cross member rear and a vehicle front lower end of the floor pan are coupled in a vehicle up-down direction. A side in the width direction that constitutes the vehicle rear upper end has slants extending from inside in the width direction toward outside of a vehicle rear part.

### CROSS-REFERENCE TO RELATED APPLICATIONS

The present application claims priority from Japanese Patent Application No. 2023-013187 filed on Jan. 31, 2023, the entire contents of which are hereby incorporated by reference.

### BACKGROUND

The disclosure relates to a vehicle body frame structure.

Typically, a vehicle body frame structure that improves vehicle body rigidity is provided in a rear lower part of an automobile, for example, to reduce running noise and collision influence.

In such a vehicle body frame structure, vehicle body components such as a side frame receive a load in a torsional direction or an up-down direction due to vibrations transmitted from, for example, wheels, suspension, or a drive unit such as an engine when a vehicle runs. In addition, it is desirable to disperse a collision load generated in the vehicle body frame structure at the time of occurrence of a collision. Then, it is desirable for the vehicle body frame structure to have rigidity sufficient to withstand a large stress to be applied to a frame to improve the steering stability and the comfortability of the vehicle and reduce noise of the vehicle, for example.

For example, Japanese Unexamined Patent Application Publication (JP-A) No. 2020-117037 discloses a technique for improving vehicle body rigidity. In this technique, a cross member that forms a closed section extending in the width direction of a vehicle is formed between a rear cross member and a kick-up member provided below a rear seat and is joined to a high floor member, and reinforcements are provided on the vehicle rear side of the cross member, thus improving the vehicle body rigidity (see, for example, JP-A No. 2020-117037).

### SUMMARY

An aspect of the disclosure provides a vehicle body frame structure for a vehicle. The vehicle body frame structure includes side sills, a cross member, and a floor pan. The side sills extend in a front-rear direction of the vehicle on respective sides in a width direction of the vehicle. The cross member extends in the width direction of the vehicle in a central part of the vehicle in the front-rear direction, the cross member being coupled to the side sills at respective ends in the width direction. The floor pan extends toward a vehicle rear side of the cross member in a lower part of the vehicle. The cross member comprises a cross member front and a cross member rear coupled to each other, the cross member front constitutes a wall surface on a vehicle front side of the cross member, and the cross member rear constitutes a wall surface on the vehicle rear side of the cross member. A vehicle rear upper end of the cross member rear and a vehicle front lower end of the floor pan are coupled to each other in an up-down direction of the vehicle. A side in the width direction that constitutes the vehicle rear upper end of the cross member rear has slants extending from inside in the width direction toward outside of a rear part of the vehicle.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a configuration diagram of a vehicle body frame structure of a vehicle according to an embodiment of the disclosure when viewed from below;

FIG. 2 is an enlarged configuration diagram of a cross member stiffener illustrated in FIG. 1 when viewed from below;

FIG. 3 is a sectional view taken along line III-III when viewed in the direction of arrows III in FIG. 2;

FIG. 4 is a sectional view taken along line IV-IV when viewed in the direction of arrows IV in FIG. 2; and

FIG. 5 is a configuration diagram illustrating a load transmitted to the vehicle body frame structure in FIG. 1.

### DETAILED DESCRIPTION

It is desirable to increase the volume of a fuel tank to increase the cruising distance of a vehicle, or it is desirable to increase the size of a battery unit to increase the volume of the battery unit to increase the cruising distance of an electric automobile, for example. The fuel tank and the battery unit may be installed in an underfloor space on the vehicle lower side of a rear seat. Thus, it is desirable to form a sufficient underfloor space to increase the size of a fuel tank or a battery unit.

However, in the technique described in JP-A No. 2020-117037, the cross member provided on the vehicle lower side of the rear seat extends in the width direction of the vehicle so as to have a substantially uniform width, and the reinforcements are provided on the vehicle rear side of the cross member. That is, the cross member and the reinforcements occupy the underfloor space on the vehicle rear side of the rear seat. This configuration may inhibit an increase in the size of a fuel tank or a battery unit.

It is desirable to provide a vehicle body frame structure that improves vehicle body rigidity while having a sufficient underfloor space.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

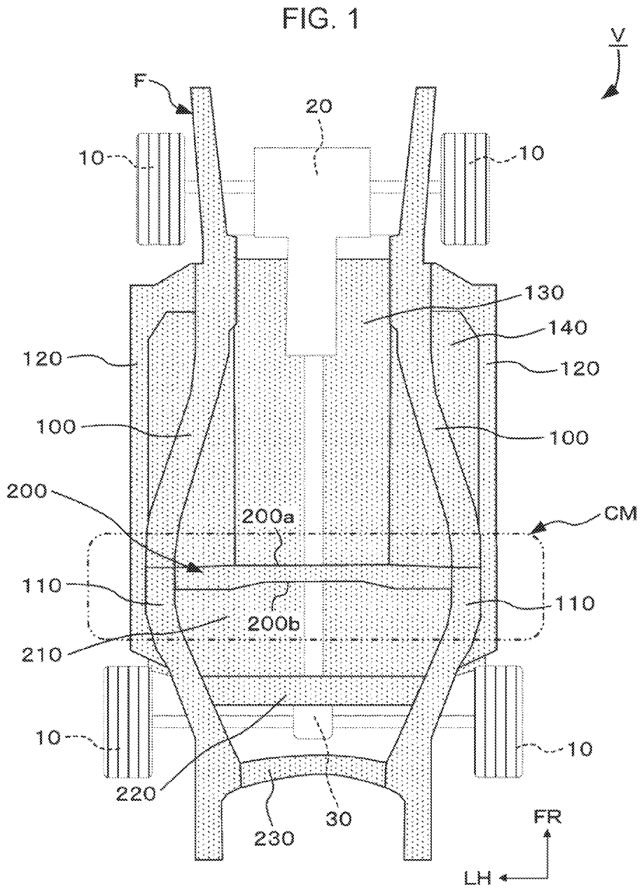

A vehicle V, to which a vehicle body frame structure F according to the present embodiment is applied, will be described below with reference to FIGS. 1 to 5. An arrow FR appropriately illustrated in the figures represents the front side of the vehicle V illustrated in FIG. 1, an arrow UP represents the upper side in front view, and an arrow LH represents the left side in front view. In addition, in the following description using an up-down direction, a front-rear direction, and a left-right direction, these respective directions represent an up-down direction in front view, a front-rear direction in front view, and a left-right direction in front view unless otherwise noted.

### EMBODIMENT

The configuration of the vehicle body frame structure F according to the present embodiment included in the vehicle V will be described with reference to FIGS. 1 to 4.

### Configuration of Vehicle V

For example, the vehicle V is an automobile in which an internal combustion engine or an electric motor is disposed as a drive source in a power unit 20. For example, the vehicle V may be a hybrid electric automobile including an engine and an electric motor serving as multiple drive sources.

As illustrated in FIG. 1, the vehicle V is formed by including wheels 10, the power unit 20, a rear-wheel drive unit 30, and the vehicle body frame structure F (hatched part in FIG. 1).

The power unit 20 is a drive unit that is configured to drive the wheels 10 and that is formed by, for example, an internal combustion engine or a motor, a transmission, a clutch, a drive shaft, and a propeller shaft, which are not illustrated. For example, the power unit 20 is disposed in a front part of the vehicle V and is supported by the vehicle body frame structure F.

The rear-wheel drive unit 30 is disposed at a vehicle rear part of the propeller shaft included in the power unit 20. The rear-wheel drive unit 30 transmits, to the wheels 10 on the rear side of the vehicle V, a driving force transmitted from the power unit 20 and smooths out the difference in rotation speed between the left and right wheels 10.

### Configuration of Vehicle Body Frame Structure F

The vehicle body frame structure F is formed by including front side frames 100, rear side frames 110, side sills 120, a floor tunnel 130, a floor panel 140, a cross member 200, a floor pan 210, and rear cross members 220 and 230.

### Front Side Frames 100

A pair of the front side frames 100 are provided on the respective sides, in the width direction of the vehicle V, of the front part of the vehicle V. The front side frames 100 are located on the outside, in the width direction of the vehicle V, of the power unit 20 configured to drive the vehicle V. The front side frames 100 extend in the front-rear direction of the vehicle V. The front side frames 100 are made of, for example, a highly rigid metal and each have a substantially rectangular closed sectional shape.

Between the front side frames 100 on the respective sides in the width direction of the vehicle V, a vehicle front end portion of the floor tunnel 130 is coupled on the vehicle rear side of the power unit 20, and respective end portions of the cross member 200 in the width direction of the vehicle V are coupled in a central part of the vehicle V in the front-rear direction.

In addition, vehicle front end portions of the rear side frames 110, which are described later, are coupled to respective vehicle rear end portions of the front side frames 100 in the front-rear direction of the vehicle V.

### Rear Side Frames 110

A pair of the rear side frames 110 are provided on the respective sides, in the width direction of the vehicle V, of a rear part of the vehicle V. The rear side frames 110 extend from respective vehicle rear parts of the front side frames 100 in the front-rear direction of the vehicle V. The rear side frames 110 are made of, for example, a highly rigid metal and each have a substantially rectangular closed sectional shape. The vehicle rear end portions of the front side frames 100 are coupled to the respective vehicle front end portions of the rear side frames 110.

Between the rear side frames 110 on the respective sides in the width direction of the vehicle V, the respective end portions of the cross member 200, which is described later, in the width direction of the vehicle V are coupled on the upper surface sides of the vehicle front end portions of the rear side frames 110, and respective end portions of the rear cross members 220 and 230 in the width direction of the vehicle V are coupled on the rear side of the vehicle V. The rear side frames 110 are main frames of the vehicle body frame structure F on the rear side of the vehicle V relative to the central part of the vehicle V in the front-rear direction.

### Side Sills 120

The side sills 120 are provided at the side bottoms on the respective sides of the vehicle V in the width direction of the vehicle V. The side sills 120 are frames extending in the front-rear direction of the vehicle V. The side sills 120 are made of, for example, a highly rigid metal and each have a substantially rectangular closed sectional shape. In addition, the front side frames 100, the rear side frames 110, and the cross member 200 are coupled to the side sills 120 by, for example, welding in the central part of the vehicle V in the front-rear direction.

### Floor Tunnel 130

At the bottom of the vehicle V, the floor tunnel 130 has a substantially U-shape so as to extend toward the inside of the vehicle interior on the upper side of the vehicle V such that the lower side of the vehicle V is open. The floor tunnel 130 extends in the front-rear direction of the vehicle V in a central part of the vehicle V in the width direction. The floor tunnel 130 is a frame in the central part of the vehicle V in the width direction. The floor tunnel 130 is made of, for example, a highly rigid metal. A vehicle rear part of the power unit 20 is fixed at the vehicle front end side of the floor tunnel 130.

### Floor Panel 140

The floor panel 140 is a floor material that is made of, for example, a steel plate and that is provided in a lower part of the vehicle V between the outside and the inside of the vehicle V. The floor panel 140 is disposed so as to extend in the front-rear direction and the width direction of the vehicle V. In addition, the floor panel 140 is fixed to each frame forming the vehicle body frame structure F by, for example, welding.

### Cross Member 200

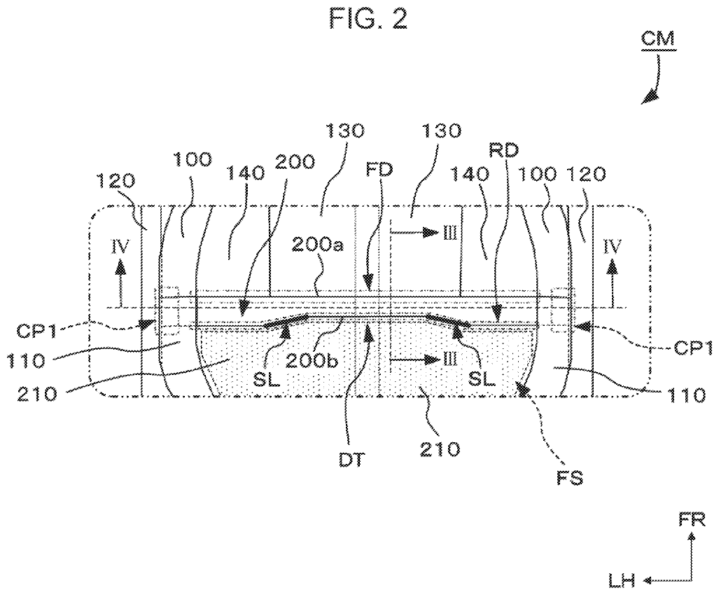

As illustrated in FIG. 2, the cross member 200 extends in the width direction of the vehicle V in the central part of the vehicle V in the front-rear direction. The respective end portions of the cross member 200 are coupled to the side sills 120 on the respective sides in the width direction of the vehicle V by, for example, welding. On the vehicle lower side of the cross member 200, the rear side frames 110 are disposed at respective coupling parts CP1, which are parts coupling the rear side frames 110 and the respective side sills 120. The rear side frames 110 are coupled to the respective coupling parts CP1 by, for example, welding. In addition, the cross member 200 has slants SL (thick solid lines in FIG. 2) extending, from the central part of the vehicle V in the width direction of the vehicle V, outward of the rear part of the vehicle V toward the respective coupling parts CP1, which are parts coupling the cross member 200 and the respective side sills 120.

The cross member 200 is made of, for example, a metal. A cross member front 200a, which forms a wall surface on the front side of the vehicle V, and a cross member rear 200b, which forms a wall surface on the rear side of the vehicle V, are coupled to form a substantially rectangular closed sectional shape.

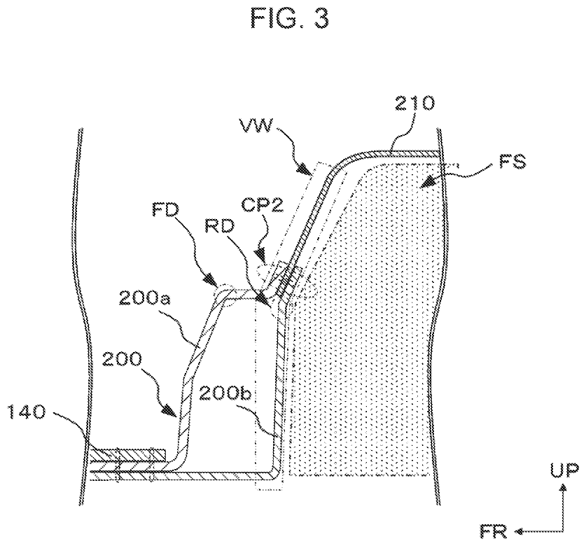

For example, as illustrated in FIG. 3, the cross member front 200a forms a side wall surface on the front side of the vehicle V and a top surface on the front side of the vehicle V of the cross member 200. The vehicle lower side of the cross member front 200a is coupled to the floor panel 140. The vehicle front upper side of the cross member front 200a forms an edge line FD.

The vehicle lower side of the cross member rear 200b, together with the cross member front 200a, is coupled to the floor panel 140. In addition, the vehicle rear upper side of the cross member rear 200b forms an edge line RD having the slants SL. The edge line RD extends in the width direction of the vehicle V between the side sills 120, which are coupled to the cross member 200 and are on the respective sides in the width direction of the vehicle V. Then, in the central part of the vehicle V in the width direction, the cross member rear 200b has a recess DT, which is formed by the slants SL of the edge line RD and is recessed from the rear side toward the front side of the vehicle V. In addition, the vehicle rear upper end of the cross member rear 200b is coupled to the vehicle front lower end of the floor pan 210 in the up-down direction of the vehicle V at a coupling part CP2 on the vehicle upper side of the cross member rear 200b. In addition, the vehicle rear upper end of the cross member front 200a and the vehicle rear upper end of the cross member rear 200b are coupled to the vehicle front lower end of the floor pan 210, which is described later, at the coupling part CP2 such that these three ends overlap each other.

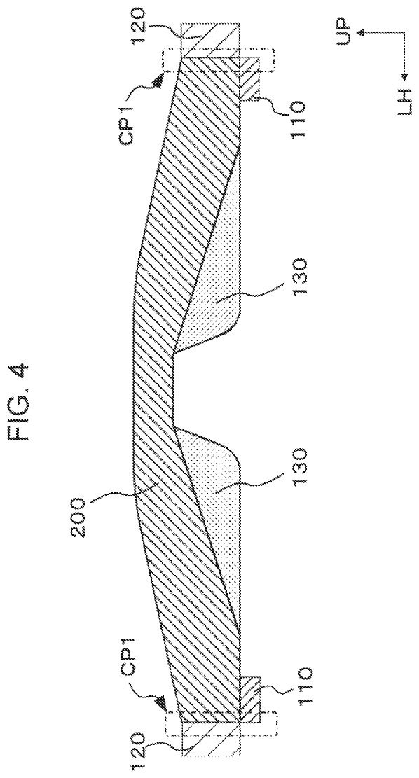

In addition, as illustrated in FIG. 4, the cross member 200 has an arch shape in which the central part of the vehicle V in the width direction is closest to the upper side of the vehicle V.

The cross member 200 is a frame extending in the width direction of the vehicle V in the central part of the vehicle V in the front-rear direction. The cross member 200 is provided with a cross member stiffener CM. The cross member stiffener CM is described later.

### Floor Pan 210

As illustrated in FIG. 1, the floor pan 210 is a floor material made of, for example, a steel plate between a cabin (not illustrated) in which, for example, an occupant is seated and the outside of the vehicle V including the vehicle body frame structure F. The floor pan 210 extends in the vehicle width direction of the lower part of the vehicle V and the vehicle rear direction of the cross member 200. The floor pan 210 is surrounded by strong frames. For example, the vehicle front side of the floor pan 210 is coupled to the cross member 200, the vehicle rear side of the floor pan 210 is coupled to the rear cross member 220, and the respective sides, in the width direction of the vehicle V, of the floor pan 210 are coupled to the respective rear side frames 110. In addition, the cabin is provided on the vehicle upper side of the floor pan 210. An underfloor space FS is formed on the vehicle lower side of the floor pan 210 and accommodates, for example, a fuel tank or a battery unit (not illustrated). The underfloor space FS is a space in which the vehicle front side is surrounded by the cross member 200, the vehicle upper side is surrounded by the floor pan 210, the respective sides in the width direction of the vehicle V are surrounded by the respective rear side frames 110, and the vehicle rear part is surrounded by the rear cross member 220.

### Rear Cross Members 220 and 230

The rear cross members 220 and 230 extend in the width direction of the vehicle V on the rear side of the vehicle V. The respective end portions of the rear cross members 220 and 230 are coupled to the rear side frames 110 on the respective sides in the width direction of the vehicle V by, for example, welding. The rear cross members 220 and 230 are made of, for example, a metal and each have a substantially rectangular closed sectional shape.

### Cross Member Stiffener CM

The cross member stiffener CM, which improves the rigidity of the cross member 200 to improve the rigidity of the vehicle body frame structure F, is provided around the cross member 200 provided in the central part of the vehicle V in the front-rear direction.

As illustrated in FIG. 2, the vehicle front upper side of the cross member front 200a of the cross member 200 has the edge line FD, and the vehicle rear upper side of the cross member rear 200b of the cross member 200 has the edge line RD. For example, the vehicle front upper side of the cross member front 200a has the edge line FD, which is substantially straight in the width direction of the vehicle V. The vehicle upper side of the cross member rear 200b has the edge line RD, which has the slants SL. The cross member 200 has a width in the front-rear direction of the vehicle V between the edge line FD and the edge line RD. The width, in the front-rear direction of the vehicle V, of the respective end portions of the cross member 200 in the width direction of the vehicle V is larger than the width, in the front-rear direction of the vehicle V, of a central part of the cross member 200 in the width direction of the vehicle V.

In addition, as illustrated in FIG. 3, the cross member rear 200b is coupled to a vehicle front end portion of the floor pan 210 in the up-down direction of the vehicle V at the coupling part CP2 on the vehicle upper side of the cross member rear 200b. Thus, a vertical wall VW, which extends in the up-down direction of the vehicle V, is formed on the vehicle rear side of the cross member 200. Then, a vehicle upper end portion of the cross member front 200a, a vehicle upper end portion of the cross member rear 200b, and the vehicle front end portion of the floor pan 210, which is described later, are coupled to each other at the coupling part CP2 such that these three end portions overlap each other.

In addition, as illustrated in FIG. 4, the cross member 200 has an arch shape in which the central part of the vehicle V in the width direction is closest to the upper side of the vehicle V. In addition, the respective end portions of the cross member 200 in the width direction of the vehicle V are coupled to the side sills 120 at the respective coupling parts CP1. In addition, the respective end portions of the cross member 200 in the width direction of the vehicle V are coupled to the rear side frames 110.

### Operations and Effects

The vehicle body frame structure F according to the embodiment formed as described above strongly stiffens frames in the central part of the vehicle V in the front-rear direction. The operation of the cross member stiffener CM will be described below with reference to FIGS. 2 to 5.

In the vehicle body frame structure F, a load generated by, for example, torsion or vibrations in the up-down direction of the vehicle V is transmitted to structural components such as the front side frames 100 due to vibrations transmitted from, for example, the wheels 10, suspension (not illustrated), or the power unit 20 when the vehicle V runs.

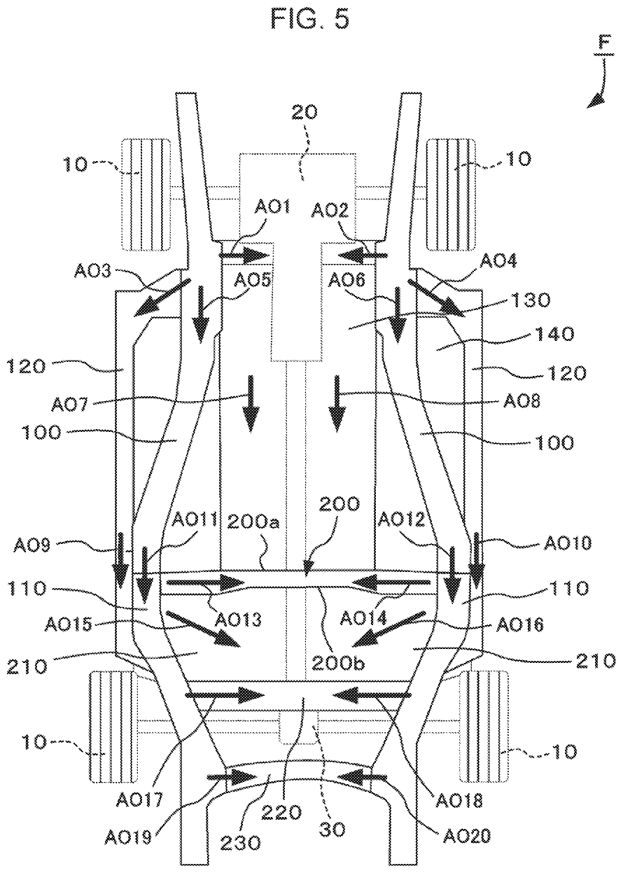

As illustrated in FIG. 5, for example, a load generated by vibrations transmitted from the wheels 10 on the front side of the vehicle V disperses and is transmitted to a vehicle front part of the floor tunnel 130, the side sills 120, and other components via the front side frames 100 as represented by arrows AO1 to AO6. In addition, a load generated by, for example, torsion or vibrations transmitted from the power unit 20 disperses and is transmitted to the floor tunnel 130 as represented by arrows AO7 and AO8. Then, the load transmitted from the front side frames 100 and the side sills 120 is transmitted to the vehicle rear sides of the rear side frames 110 and the side sills 120 as represented by arrows AO9 to AO12.

On the other hand, as illustrated in FIG. 2, the cross member 200 is coupled to the side sills 120 and the rear side frames 110 at the respective coupling parts CP1. In addition, the width, in the front-rear direction of the vehicle V, of the respective end portions of the cross member 200 in the width direction of the vehicle V is larger than the width, in the front-rear direction of the vehicle V, of the central part of the cross member 200 in the width direction of the vehicle V. In addition, as illustrated in FIG. 4, the cross member 200 has an arch shape in which the central part of the vehicle V in the width direction is closest to the upper side of the vehicle V. Thus, the cross member 200 has a shape that improves rigidity and is stiffened by being coupled to the side sills 120 and the rear side frames 110 at the respective coupling parts CP1 to form a strong frame.

In addition, as illustrated in FIG. 3, the cross member rear 200b forming the cross member 200 is coupled to the vehicle front lower end of the floor pan 210 in the up-down direction of the vehicle V at the coupling part CP2 on the vehicle upper side of the cross member rear 200b to form the vertical wall VW extending in the up-down direction of the vehicle V. Then, the cross member front 200a, the cross member rear 200b, and the floor pan 210 are coupled to each other at the coupling part CP2 such that these three components overlap each other. Thus, the cross member 200 is stiffened by being coupled to the floor pan 210 at the coupling part CP2 and is a strong frame.

Then, the load transmitted from the front side frames 100 and the side sills 120 is efficiently transmitted to the stiffened cross member 200 as represented by arrows AO13 and AO14. In addition, the load transmitted to the cross member 200 disperses to the frames coupled to the periphery of the cross member 200 via the floor pan 210 as represented by arrows AO15 and AO16. In addition, the load transmitted to the rear side frames 110 disperses to the rear cross members 220 and 230 as represented by arrows AO17 to AO20.

On the other hand, the vehicle body frame structure F is formed by mainly using an underfloor space, and, for example, a battery unit usable in an electric automobile may be accommodated in the underfloor space FS, which is formed on the vehicle rear side of the cross member 200. Thus, it is desirable to provide a vehicle body frame structure F having a large underfloor space FS while achieving sufficient vehicle rigidity.

As illustrated in FIG. 2, the underfloor space FS is formed on the vehicle rear side of the cross member 200. The underfloor space FS is a space in which the vehicle front part is surrounded by the cross member 200, the vehicle upper side is surrounded by the floor pan 210, the respective sides in the width direction of the vehicle V are surrounded by the respective rear side frames 110, and the vehicle rear part is surrounded by the rear cross member 220.

The recess DT along the edge line RD having the slants SL is formed on the vehicle rear side of the central part of the cross member 200 in the width direction of the vehicle V. The recess DT forms a space that expands the underfloor space FS toward the front side of the vehicle V. In addition, as illustrated in FIG. 3, the underfloor space FS is formed on the vehicle rear side of the part where the cross member rear 200b and the floor pan 210 are coupled to each other. In this case, the cross member rear 200b and the floor pan 210 are coupled to each other so as to form the vertical wall VW extending in the up-down direction of the vehicle V. Thus, the coupling part CP2, where the cross member rear 200b and the floor pan 210 are coupled to each other, does not have a shape projecting toward the underfloor space FS. In other words, a space that expands the underfloor space FS toward the front side of the vehicle V is formed on the vehicle rear side of the part where the cross member rear 200b and the floor pan 210 are coupled to each other.

As described above, the vehicle body frame structure F according to the embodiment includes the side sills 120, which extend in the front-rear direction of the vehicle V on the respective sides in the width direction of the vehicle V, the cross member 200, which extends in the width direction of the vehicle V in the central part of the vehicle V in the front-rear direction and is coupled to the side sills 120 at the respective ends of the vehicle V in the width direction, and the floor pan 210, which extends toward the vehicle rear side of the cross member 200 in the lower part of the vehicle V. The cross member 200 is formed by coupling the cross member front 200a, which forms the wall surface on the vehicle front side of the cross member 200, and the cross member rear 200b, which forms the wall surface on the vehicle rear side of the cross member 200. The vehicle rear upper end of the cross member rear 200b and the vehicle front lower end of the floor pan 210 are coupled to each other in the up-down direction of the vehicle V. A side, in the width direction of the vehicle V, forming the vehicle rear upper end of the cross member rear 200b has the slants SL extending from the inside in the width direction of the vehicle V toward the outside of the rear part of the vehicle V.

That is, the cross member 200 is formed such that the width, in the front-rear direction of the vehicle V, of the outside of the cross member 200 in the width direction of the vehicle V is larger than the width, in the front-rear direction of the vehicle V, of the central part of the cross member 200 in the width direction of the vehicle V. In addition, the side sills 120 and the rear side frames 110 are coupled to each other at the respective coupling parts CP1. Thus, the cross member 200 is stiffened and is a strong frame. Accordingly, the load transmitted from the front side frames 100 or the side sills 120 is efficiently transmitted to the cross member 200 and can efficiently disperse to the rear side frames 110 and the rear cross members 220 and 230 via the floor pan 210.

In addition, the recess DT along the edge line RD having the slants SL is formed on the vehicle rear side of the central part of the cross member 200 in the width direction of the vehicle V. The recess DT forms a space that expands the underfloor space FS toward the front side of the vehicle V. Thus, it is possible to form a sufficient underfloor space.

As a result, it is possible to improve vehicle body rigidity while forming a sufficient underfloor space.

In addition, in the vehicle body frame structure F according to the embodiment, the vehicle rear upper end of the cross member front 200a is coupled to the coupling part CP2, where the vehicle rear upper end of the cross member rear 200b and the vehicle front lower end of the floor pan 210 are coupled to each other in the up-down direction of the vehicle V.

That is, the cross member front 200a, the cross member rear 200b, and the floor pan 210 are coupled to each other at the coupling part CP2 such that these three components overlap each other. Then, the cross member rear 200b and the floor pan 210 are coupled to each other on the vehicle upper side of the cross member rear 200b to stiffen the vertical wall VW formed in the up-down direction on the vehicle rear side of the cross member 200. Accordingly, the load transmitted to the cross member 200 can efficiently disperse to the stiffened vertical wall VW. In addition, these three components are coupled to each other so as to overlap each other to enable a reduction in the number of coupling parts and can thus be coupled to each other without structural components projecting toward the underfloor space FS.

As a result, it is possible to improve vehicle body rigidity while forming a sufficient underfloor space.

In the embodiment of the disclosure, the vehicle rear upper end of the cross member rear 200b is coupled to the cross member front 200a and the vehicle front lower end of the floor pan 210 at the coupling part CP2 on the vehicle upper side of the cross member rear 200b such that these three components overlap each other. However, the cross member front 200a, the cross member rear 200b, and the floor pan 210 may be made of, for example, respective steel plates having different thicknesses and may be coupled to each other such that these three components overlap each other to stiffen the vertical wall VW at the coupling part CP2.

The embodiment of the disclosure has been described above in detail with reference to the drawings. However, the configuration examples are not limited to the embodiment and include designs without departing from the gist of the disclosure.

1. A vehicle body frame structure for a vehicle, the vehicle body frame structure comprising:
side sills extending in a front-rear direction of the vehicle on respective sides in a width direction of the vehicle;
a cross member extending in the width direction in a central part of the vehicle in the front-rear direction, the cross member being coupled to the side sills at respective ends in the width direction; and
a floor pan extending toward a vehicle rear side of the cross member in a lower part of the vehicle, wherein
the cross member comprises a cross member front and a cross member rear coupled to each other, the cross member front constitutes a wall surface on a vehicle front side of the cross member, and the cross member rear constitutes a wall surface on the vehicle rear side of the cross member,
a vehicle rear upper end of the cross member rear and a vehicle front lower end of the floor pan are coupled to each other in an up-down direction of the vehicle, and
a side in the width direction that constitutes the vehicle rear upper end of the cross member rear has slants extending from inside in the width direction toward outside of a rear part of the vehicle.

2. The vehicle body frame structure according to claim 1, wherein a vehicle rear upper end of the cross member front is coupled to a coupling part where the vehicle rear upper end of the cross member rear and the vehicle front lower end of the floor pan are coupled to each other in the up-down direction.
